(19) United States
(12) Patent Application Publication
(10) Pub. No.: US 2015/0176747 A1
(43) Pub. Date: Jun. 25, 2015

(54) CONNECTOR COVER

(71) Applicants: TOGO SEISAKUSYO CORPORATION, Aichi (JP); KURASHIKI KAKO CO., LTD., Okayama (JP)

(72) Inventors: Takanori Nagaya, Aichi (JP); Toshio Hayashi, Okayama (JP)

(21) Appl. No.: 14/408,225

(22) PCT Filed: Apr. 26, 2013
(86) PCT No.: PCT/JP2013/062434

§ 371 Date: Dec. 15, 2014

(30) Foreign Application Priority Data
Jun. 29, 2012 (JP) 2012-146812

(51) Int. Cl. F16L 57/00

(52) U.S. Cl. CPC F16L 57/005

(57) ABSTRACT

Embodiments of the present invention may include a connector cover covers a connector body having a pipe connection portion to which a pipe is connected and a tube connection portion to which a tube is connected. The connector cover has two divisional bodies formed through division in a radial direction of the connector body and configured to be capable of being engaged with each other. At least one of the divisional bodies has a large-diameter fit-engagement portion fit-engaged with a divergent portion of the tube connected to the tube connection portion, and a small-diameter fit-engagement portion which is of a smaller opening diameter than that of the large-diameter fit-engagement portion and which is fit-engaged with a non-divergent portion of the tube adjacent to the large-diameter fit-engagement portion.

### PRIORITY CLAIM

The present application is a National Phase entry of PCT Application No. PCT/JP2013/062434, filed Apr. 26, 2013, which claims priority from Japanese Patent Application No. 2012-146812, filed Jun. 29, 2012, the disclosures of which are hereby incorporated by reference herein in their entirety.

### BACKGROUND OF THE INVENTION

Embodiments of the present invention relate to a connector cover for protecting a connector body that connects a pipe and a tube to each other.

### DESCRIPTION OF THE RELATED ART

Japanese Laid-Open Patent Publication No. 2006-22911 discloses a connector cover in embodiment 2. As shown in FIG. 19, a conventional connector 103 connects a pipe 100P and a tube 100T to each other. The connector 103 has a connector body 118. The connector body 118 has a pipe connection portion 159 to which the pipe 100P is connected and a tube connection portion 111 to which the tube 100T is connected. The connector 103 is provided with a tubular connector cover 160 covering the connector body 118. The connector cover 160 is configured with two divisional bodies 161 and 162 obtained through division in the radial direction (right-left direction) of the connector body 118. The right and left divisional bodies 161 and 162 are formed symmetrically. Mounting protrusions 135 are formed on the right and left side surfaces of the connector body 118. Boss hole portions 136 to be engaged with the mounting protrusions 135 are formed in the inner side surfaces of the two divisional bodies 161 and 162.

The tube 100T is connected to the tube connection portion 111 of the connector body 118. After this, the mounting protrusions 135 are engaged with the boss hole portions 136, whereby the two divisional bodies 161 and 162 are attached to the connector body 118. The connector cover 160 formed by the two divisional bodies 161 and 162 protect the connector body 118 from an external shock. The tube 100T has a divergent portion diverged by the tube connection portion 111, and a non-divergent portion not diverged by the tube connection portion 111. The divergent portion of the tube 100T and the non-divergent portion adjacent to the divergent portion are covered with the connector cover 160.

The mounting protrusions 135 for attaching the connector cover 160 to the connector body 118 are formed on the connector body 118. Thus, the design of the connector body 118 is influenced by the structure for attaching the connector cover 160. The connector cover 160 has a cylindrical portion covering the tube 100T. The cylindrical portion has a diameter allowing the fit-engagement of the divergent portion of the tube 100T. Thus, between the cylindrical portion and the non-divergent portion of the tube 100T, there is formed an annular gap open to the exterior. There is a fear that foreign matter may be allowed to enter the two divisional bodies 161 and 162 through the gap.

Thus, there is a need for a connector cover capable of preventing intrusion of foreign matter into the cover without necessitating a change in the design of the connector body.

### SUMMARY OF THE INVENTION

According to one aspect of the present invention, a connector cover covers a connector body having a pipe connection portion to which a pipe is connected and a tube connection portion to which a tube is connected. The connector cover has two divisional bodies formed through division in a radial direction of the connector body and configured to be capable of being engaged with each other. At least one of the divisional bodies has a large-diameter fit-engagement portion fit-engaged with a divergent portion of the tube connected to the tube connection portion, and a small-diameter fit-engagement portion which is of a smaller opening diameter than that of the large-diameter fit-engagement portion and which is fit-engaged with a non-divergent portion of the tube adjacent to the large-diameter fit-engagement portion.

Thus, the divisional bodies are engaged with each other, with the connector body therebetween. As a result, the connector cover covers the periphery of the connector body.

The connector body is provided with no attachment structure for attaching the connector cover to the connector body. Thus, unlike the conventional example (See FIG. 19), the present embodiment allows formation of an attachment structure without a design change for the connector body. Further, the divergent portion of the tube is fit-engaged with the large-diameter fit-engagement portion. The non-divergent portion of the tube is fit-engaged with the small-diameter fit-engagement portion of the tube. As a result, the gap between the small-diameter fit-engagement portion of the connector cover and the non-divergent portion of the tube is decreased. This makes it possible to prevent intrusion of foreign matter into the connector cover from the gap.

According to another aspect of the present invention, the divisional bodies may be asymmetrical with respect to each other in a radial direction of the connector body. Thus, the divisional bodies can be easily distinguished from each other.

According to another aspect of the present invention, there may be provided with a rattling prevention means configured to prevent mutual rattling of the divisional bodies by utilizing elasticity of at least one of the divisional bodies. Thus, by utilizing the elasticity of the divisional body, it is possible to effectively prevent mutual rattling of the divisional bodies.

### BRIEF DESCRIPTION OF THE DRAWINGS

FIG. 1 is a perspective view of an embodiment in which a connector cover is attached to a connector;

FIG. 2 is a perspective view of the embodiment before the connector cover is attached to the connector;

FIG. 3 is a perspective view of the embodiment before a tube is connected to the connector;

FIG. 4 is a cross-sectional view of the embodiment in which the tube is connected to the connector;

FIG. 5 is a front view of a cover body;

FIG. 6 is a view of the left side of the cover body;

FIG. 7 is a plane view of the cover body;

FIG. 8 is a bottom view of the cover body;

FIG. 9 is a cross-sectional view taken along line IX-IX in FIG. 5;

FIG. 10 is a cross-sectional view taken along line X-X in FIG. 5;

FIG. 11 is a front view of the embodiment in which the connector is fit-engaged to the cover body;

FIG. 12 is a front view of a lid;

FIG. 13 is a view of the left side of the lid;

FIG. 14 is a plane view of the lid;

FIG. 15 is a bottom view of the lid;

FIG. 16 is a cross-sectional view taken along line XVI-XVI in FIG. 12;

FIG. 17 is a cross-sectional view taken along line XVII-XVII in FIG. 12;

FIG. 18 is a cross-sectional view taken along line XVIII-XVIII in FIG. 12; and

FIG. 19 is an exploded perspective view of a conventional connector and a conventional connector cover.

### DETAILED DESCRIPTION OF THE INVENTION

An embodiment of the present invention will be described with reference to the drawings.

The present embodiment has a connector and a connector cover protecting a connector. The connector connects a pipe provided on a fuel tank of a vehicle such as an automobile to a tube of a fuel piping system. For the sake of convenience in illustration, upper, lower, left, and right directions will be determined based on a cross-sectional view of FIG. 4. These directions, however, do not specify orientation of the connector and the connector cover.

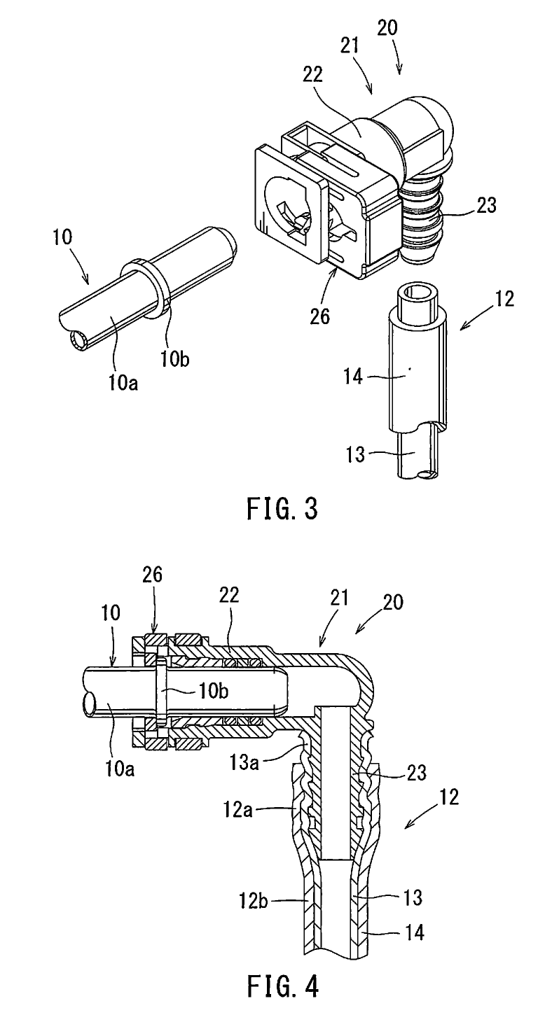

As shown in FIG. 3, a pipe 10 has a pipe body 10a with an annular sectional configuration. A bulge portion 10b has a flange shape that is continuous in the peripheral direction. The bulge portion 10b is formed on the outer peripheral surface of the pipe body 10a at a position at a predetermined distance from the distal end portion thereof. The pipe 10 may be formed of metal or of resin. A tube 12 has an inner tube member 13 formed of resin, and an outer tube member 14 formed of rubber. The tube 12 may be a double tube, a single tube, or a multiple tube such as triple tube.

A connector 20 has a connector body 21 and a retainer 26. The connector 20 may be provided with a checker for checking the propriety of the fit-engagement of the pipe 10 with respect to the connector body 21 (See, for example, Japanese Laid-Open Patent Publication No. 2004-251319). The checker is attached to the connector body 21. The pipe 10 is fit-engaged with the connector body 21. The retainer 26 is caused to slide with respect to the connector body 21. When the pipe 10 is correctly fit-engaged with the connector body 21, the checker can be detached from the connector body 21. On the other hand, when the pipe 10 is not correctly fit-engaged with the connector body 21, the checker cannot be detached from the connector body 21. The retainer 26 may be caused to slide in any direction with respect to the connector body 21. The checker may be detached in any direction with respect to the connector body 21.

The connector body 21 is formed, for example, of resin. The connector body 21 may be an elbow pipe. The connector body 21 has a pipe connection portion (horizontal pipe portion) 22 and a tube connection portion (vertical pipe portion) 23. The pipe connection portion 22 has an opening that opens the left end. The tube connection portion 23 extends downward from the right end of the pipe connection portion 22, and has an opening that opens the lower end. The pipe 10 can be coaxially inserted into the pipe connection portion 22. The tube connection portion 23 has a bamboo-shoot shape alternately exhibiting large-diameter portions and small-diameter portions. The distal end portion (lower end portion) of the tube connection portion 23 is tapered.

As shown in FIG. 4, the tube connection portion 23 is forced into a tube 12 (more specifically, a tube member 13). As a result, the tube 12 is connected to the tube connection portion 23. The tube 12 has a divergent portion 12a and a non-divergent portion 12b. The divergent portion 12a is a part of the tube 12, which is diverged by the tube connection portion 23 when the tube 12 is connected to the tube connection portion 23. The non-divergent portion 12b is a part of the tube 12 which is not diverged by the tube connection portion 23. The connection portion of the tube 12 connected to the tube connection portion 23 includes the divergent portion 12a and the non-divergent portion 12b adjacent to the divergent portion 12a. The distal end portion (upper end portion) 13a of the inner tube member 13 is exposed from the distal end of the outer tube member 14.

The retainer 26 is attached to the left end portion of the pipe connection portion 22 so as to be slidable in the radial direction (the drawing paper thickness direction in FIG. 4). The pipe 10 is inserted into the pipe connection portion 22 to the normal connection position. In this state, the retainer 26 is caused to slide from a temporarily engagement position on the front side to a locked position on the rear side. As a result, the retainer 26 prevents the pipe 10 (more specifically, the bulge portion 10b) from being detached from the pipe connection portion 22. The pipe connection portion 22 and the retainer 26 may be of the construction disclosed in Japanese Laid-Open Patent Publication No. 2006-22911, or of the construction disclosed in Japanese Laid-Open Patent Publication No. 2004-251319.

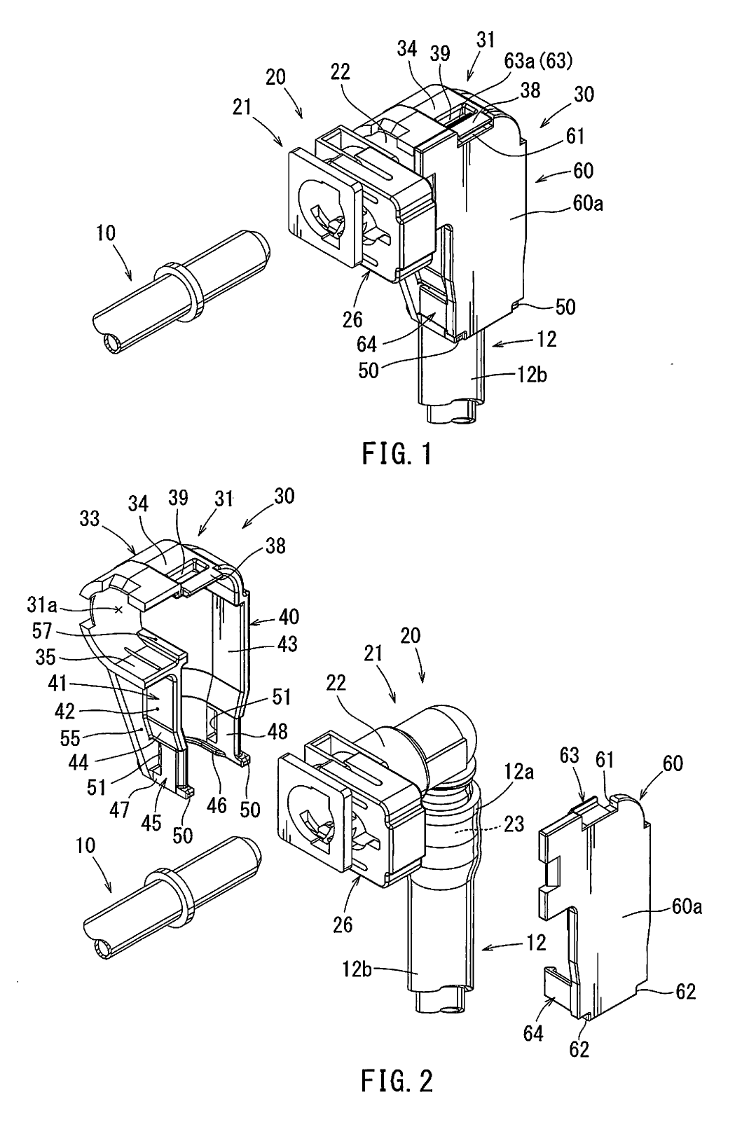

As shown in FIG. 1, a connector cover 30 is attached to the connector body 21 to which the tube 12 is connected. The connector cover 30 may be an elbow pipe. The elbow pipe covers the pipe connection portion 22 of the connector body 21 exclusive of the portion adjacent to the retainer 26, and the connection portion (See FIG. 4) of the tube 12 connected to the tube connection portion 23. In the present embodiment, the pipe 10 is connected to the connector 20 after the connector cover 30 is attached to the connector 20. However, the pipe 10 may also be connected to the connector 20 before the connector cover 30 is attached to the connector 20.

As shown in FIG. 2, the connector cover 30 is divided into two in the radial direction of the connector body 21; that is, into two divisional bodies (a cover body 31 and a lid 60) by a divisional plane that faces in a front-rear direction (the drawing paper thickness direction). The cover body 31 and the lid 60 are asymmetrical with respect to the radial direction (front-rear direction) of the connector body 21. The cover body 31 is situated on the rear side of the connector body 21, and is formed, for example, of resin. The cover body 31 is of a U-shaped cross-sectional configuration that opens on one side, i.e., the front. As compared with the lid 60, the cover body 31 covers the periphery of the connector body 21 over a wider range. The lid 60 is situated on the front side of the connector body 21. The lid 60 is formed, for example, of resin, and is of a plate shape. The lid 60 closes the front opening of the cover body 31. The cover body 31 is of a U-shaped cross-sectional configuration, alternatively may be of a rectangular cross-sectional configuration or a curved cross-sectional configuration.

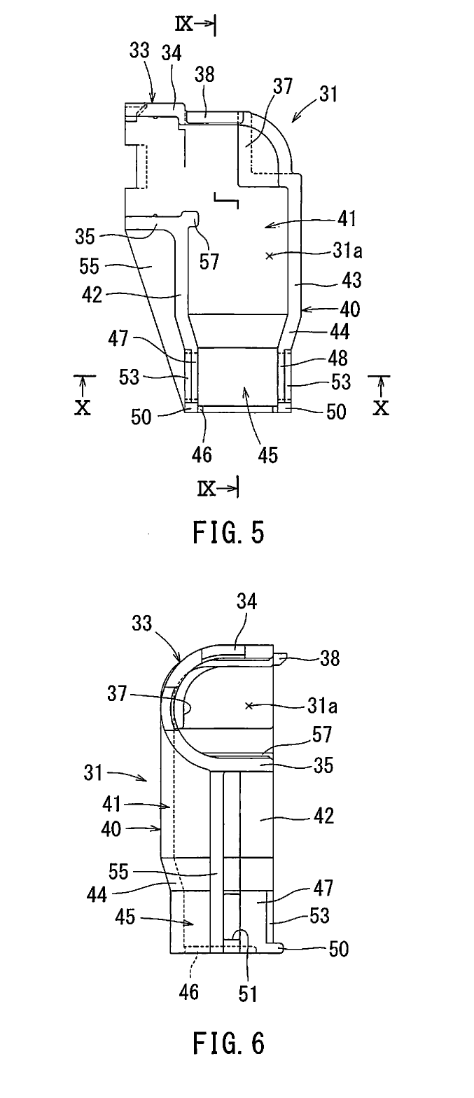

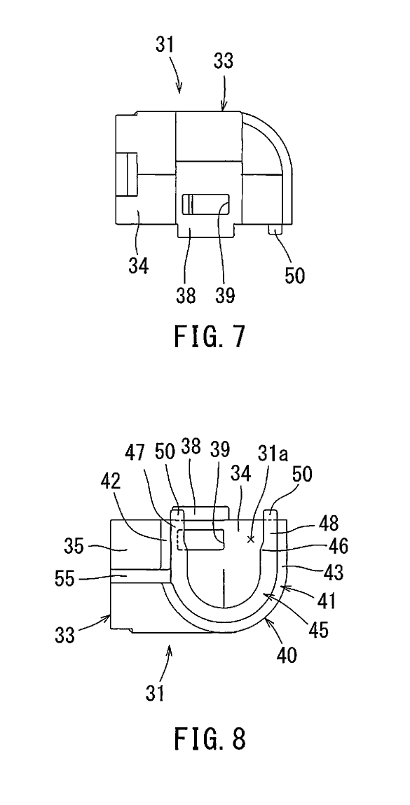

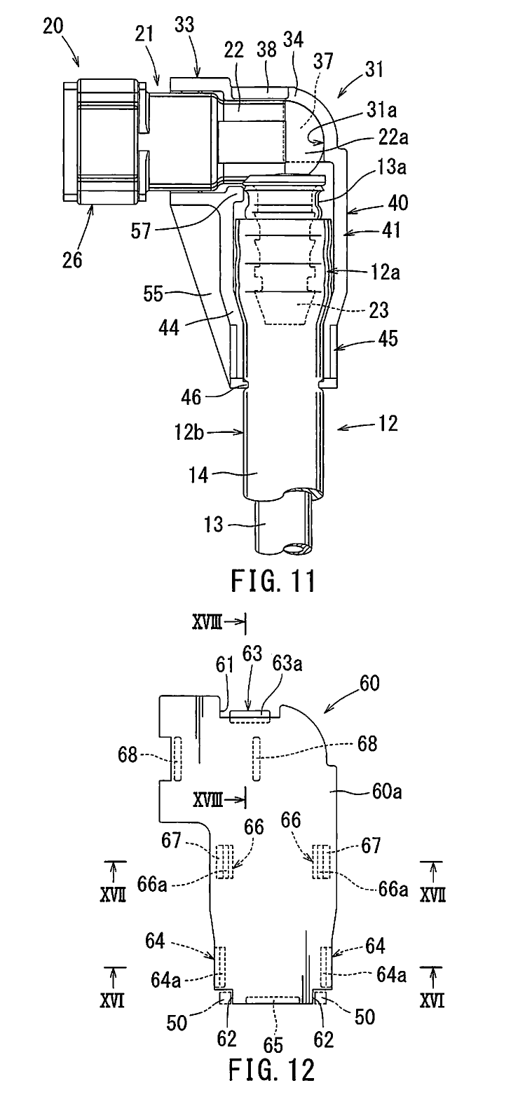

As shown in FIG. 5, the cover body 31 has a groove portion 31 a which opens the front side. The groove portion 31a is of a reverse-L-shape. The pipe connection portion 22 (See FIG. 4) of the connector body 21, excluding the portion adjacent to the retainer 26, is fit-engaged with the groove portion 31a. The connection portion of the tube 12 connected to the tube connection portion 23 is fit-engaged with the groove portion 31a from the front (from a face to back of the plane of the drawing) (See FIG. 11). The cover body 31 has a first fit-engagement portion 33 fit-engaged with the pipe connection portion 22, and a second fit-engagement portion 40 fit-engaged with the connection portion of the tube 12.

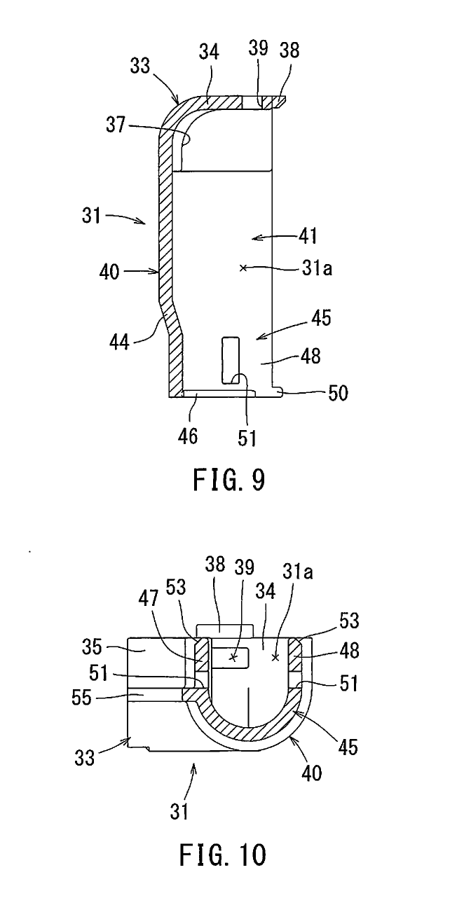

As shown in FIG. 5, a seating face 37 reducing the groove diameter is formed on the inner wall at the rear side of the right end of the first fit-engagement portion 33. The seating face 37 has a concave curved surface corresponding to a spherical portion 22a at the right end of the pipe connection portion 22 of the connector body 21 shown in FIG. 11 (See FIG. 5). The seating face 37 enhances the rigidity of the cover body 31. At the central portion of the front edge of an upper wall 34 of the first fit-engagement portion 33, there is formed a first positioning protrusion 38 protruding forward (See FIG. 6). The first positioning portion 38 is formed as a laterally elongated rectangular plate extending in the horizontal direction. A first engagement hole 39 is formed in the upper wall 34. The first engagement hole 39 vertically extends through the upper wall 34 (See FIG. 9). The first engagement hole 39 is formed as a laterally elongated rectangular hole. The first positioning protrusion 38 and the first engagement hole 39 are situated parallel to each other on the front and rear sides.

As shown in FIG. 11, the second fit-engagement portion 40 has a large-diameter fit-engagement portion 41 and a small-diameter fit-engagement portion 45. The divergent portion 12a of the tube 12 is fit-engaged with the large-diameter fit-engagement portion 41. The non-divergent portion 12b of the tube 12 is fit-engaged with the small-diameter fit-engagement portion 45. The large-diameter fit-engagement portion 41 and the small-diameter fit-engagement portion 45 are gently connected to each other by a tapered portion 44. A narrowing portion 46 reducing the groove diameter (See FIGS. 8 and 9) is formed on the semi-circular inner peripheral portion at the lower end of the small-diameter fit-engagement portion 45. The narrowing portion 46 is formed so as to be capable of fit-engagement with the outer peripheral surface of the non-divergent portion 12b of the tube 12 with a predetermined fastening margin (See FIG. 11).

As shown in FIG. 5, there are symmetrically formed second positioning portions 50 in the form of rectangular protrusions protruding forward (See FIG. 8) at the lower end portion of the front end surface of the small-diameter fit-engagement portion 45; that is, at the front end surface of a left wall 47 and of a right wall 48 of the small-diameter fit-engagement portion 45. There are symmetrically formed second engagement holes 51 horizontally extending through the walls 47 and 48 (See FIG. 10) in the left wall 47 and the right wall 48 of the small-diameter fit-engagement portion 45. The second engagement holes 51 are vertically elongated rectangular holes (See FIG. 9). On the outer sides of the front edges of the left wall 47 and the right wall 48, there are symmetrically formed guide slopes 53 situated in front of the second engagement holes 51 (on the upper side, as seen in FIG. 10).

As shown in FIG. 5, a first rib 55 with a reverse-triangle shape is formed at the inner side of the corner made by a lower wall 35 of the first fit-engagement portion 33 and the large-diameter fit-engagement portion 41 of the second fit-engagement portion 40. The lower end portion of the first rib 55 extends toward the lower end of the left wall 46 of the small-diameter fit-engagement portion 45. The first rib 55 is formed in a plane facing the front and rear directions (See FIG. 8). The first rib 55 enhances the rigidity of the cover body 31. At the connection portion between the lower wall 35 of the first fit-engagement portion 33 and the left wall 42 of the large-diameter fit-engagement portion 41 of the second fit-engagement portion 40, there is formed a second rib 57 protruding into the groove portion 31a (See FIG. 5). The second rib 57 is formed as a rectangular bar extending in the front-rear direction (the drawing paper thickness direction in FIG. 5). The second rib 57 is formed so as to be capable of fit-engagement with the inner side of the corner made by the pipe connection portion 22 and the tube connection portion 23 of the connector body (See FIG. 11). The second rib 57 enhances the rigidity of the cover body 31.

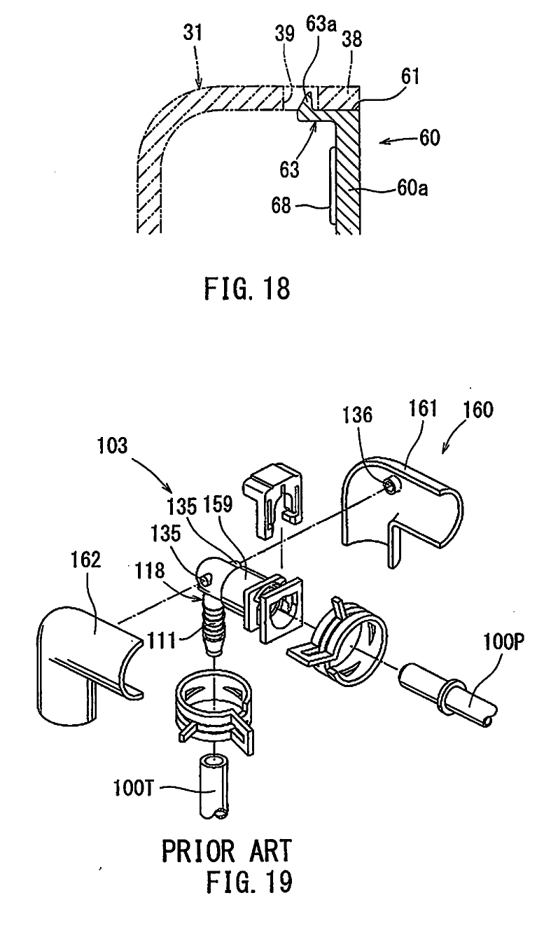

As shown in FIG. 12, the lid 60 has a cover plate 60a as a main portion. The cover plate 60a has substantially the same external configuration as that of the front end of the cover body 31 (See FIG. 5). A first positioning recess 61 that opens the upper side of the cover plate 60a is formed at the upper end of the cover plate 60a. The first positioning protrusion 38 of the cover body 31 can be engaged with the first positioning recess 61 (See FIG. 18). The first positioning protrusion 38 and the first positioning recess 61 constitute a first positioning means.

As shown in FIG. 12, second positioning recesses 62 are formed at the corner portions at both the right and left ends of the lower end of the cover plate 60a. The two second positioning recesses 62 are formed symmetrically, and provide openings on the lower and the outer sides. The two second positioning protrusions 50 of the cover body 31 can be engaged with the two second positioning recesses 62. The two second positioning protrusions 50 and the two second positioning recesses 62 constitute a second positioning means.

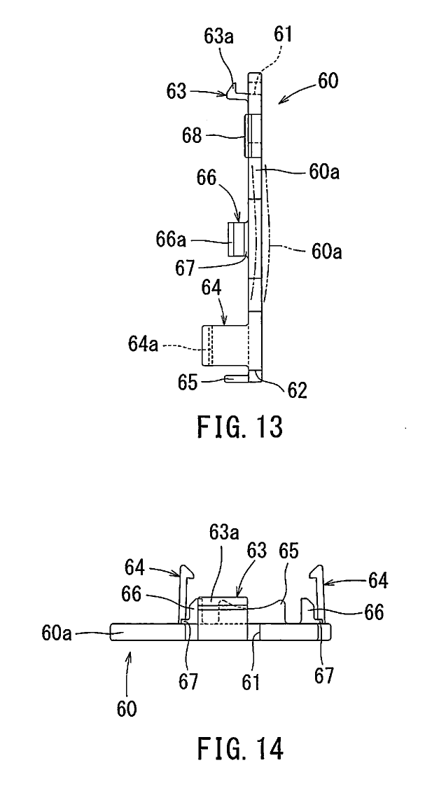

As shown in FIG. 13, on the cover plate 60a, there is formed a first engagement member 63 protruding backwards from the lower edge of the first positioning recess 61 (to the left as seen in FIG. 13). At the rear end of the first engagement member 63, there is formed an engagement claw 63a protruding upward. The first engagement member 63 is formed as a thin and elongated plate extending in the horizontal direction (See FIG. 14). The engagement claw 63a of the first engagement member 63 can be engaged with a first engagement hole 39 of the cover body 31 (See FIG. 18). The first engagement hole 39 and the first engagement member 63 constitute a first engagement means.

As shown in FIG. 12, second engagement members 64 are formed at the right and left side edge of the lower end of the cover plate 60a. The two second engagement members 64 are formed symmetrically, and protrude backward from the cover plate 60a (on the back side of the plane of FIG. 12). The two engagement members 64 are formed as thin and elongated plates extending in the vertical direction. The two engagement members 64 are on the upper side of and adjacent to the two second positioning recesses 62. Engagement claws 64a are engaged to the rear end of the two engagement members 64. As shown in FIG. 16, each engagement claw 64 protrudes towards the other engagement claw 64a. The two second engagement members 64 are elastically deformed to move away from each other, whereby the distance between the two second engagement members 64 increases (See the chain double-dashed lines 64 in FIG. 16).

The engagement claws 64a of the two second engagement members 64 can be engaged with the second engagement holes 51 of the cover body 31. The second engagement holes 51 and the second engagement members 64 constitute a second engagement means.

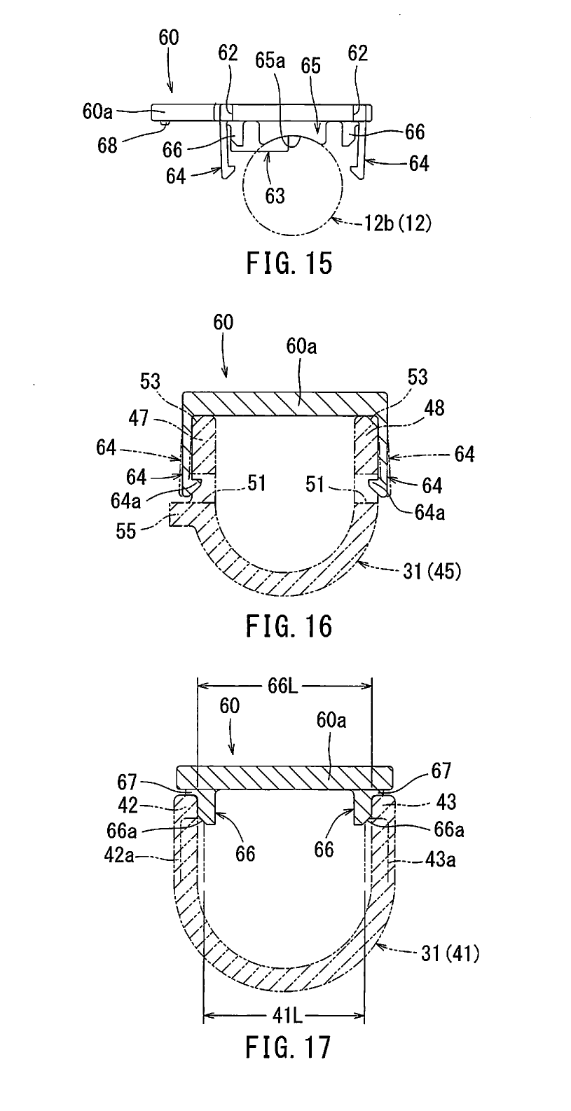

As shown in FIG. 13, at the lower edge of the cover plate 60a, there is formed a closing member 65 protruding backwards (to the left as seen in FIG. 13) (See FIG. 15). The closing member 65 is formed as a thin and elongated plate extending in the horizontal direction. A fit-engagement surface 65a is formed at the rear end of the closing member 65 (at the lower end in FIG. 15). The fit-engagement surface 65a is of a concave and arcuate shape so that it can be fit-engaged with the non-divergent portion 12b of the tube 12.

As shown in FIG. 12, a pair of right and left third ribs 66 are formed at the central portion in the vertical direction of the cover plate 60a. The two third ribs 66 are formed symmetrically, and protrude backward (on the back side of the plane of FIG. 12). The third ribs 66 are formed as thin and elongated plates extending in the vertical direction. The third ribs 66 enhance the rigidity of the cover plate 60a. The third ribs 66 can be fit-engaged between the left wall 42 and the right wall 43 of the large-diameter fit-engagement portion 41 of the cover body 31 (See FIG. 17).

As shown in FIG. 17, the distance 66L between the outer surfaces of the third ribs 66 is set to be a predetermined distance larger than the distance 41L between the left wall 42 and the right wall 43 of the large-diameter fit-engagement portion 41 in the free state of the cover body 31 (See the chain double-dashed lines 42a and 43a of FIG. 17). When the two third ribs 66 are fit-engaged between the left wall 42 and the right wall 43 of the large-diameter fit-engagement portion 41, the left wall 42 and the right wall 43 of the large-diameter fit-engagement portion 41 are elastically deformed and move away from each other. As a result, the distance between the left wall 42 and the right wall 43 is enlarged. Guide slopes 66a are formed on the outer side of the distal end of the third ribs 66. When the two third ribs 66 are fit-engaged between the left wall 42 and the right wall 43, the guide slopes 66a guide the front edges of the left wall 42 and the right wall 43 of the large-diameter fit-engagement portion 41. It is also possible to set the distance 66L and the distance 41L to the same dimension. In this case, the left wall 42 and the right wall 43 of the large-diameter fit-engagement portion 41 are not elastically deformed when the two third ribs 66 are fit-engaged.

Stepped portions 67 are formed on the outer surfaces of the proximal end of the third ribs 66. The right and left stepped portions 67 are formed symmetrically. When the lid 60 is attached to the cover body 31, the stepped portions 67 can abut the front end of the left wall 42 and the right wall 43 of the large-diameter fit-engagement portion 41 of the cover body 31. When the stepped portions 67 (more specifically, the rear surfaces) of the third ribs 66 abut the front end of the left wall 42 and the right wall 43 of the large-diameter fit-engagement portion, the central portion in the vertical direction of the cover plate 60a is elastically deformed forwardly to be deflected (See the chain double-dashed line 60a in FIG. 13). Left and right fourth ribs 68 extending in the vertical direction are formed on the rear surface of the upper end of the cover plate 60a (the back side of the plate of FIG. 12) (See FIG. 12). The fourth ribs 68 enhance the rigidity of the cover plate 60a.

Next, the procedures for attaching the connector cover 30 to the connector body 21 to which the tube 12 is connected will be described (See FIG. 2). First, the pipe connection portion 22, excluding the portion adjacent to the retainer 26, and the connection portion of the tube 12 connected to the tube connection portion 23 are fit-engaged with the groove portion 31 a of the cover body 31 (See FIG. 11). The gap between the pipe connection portion 22 and the first fit-engagement portion 33 is reduced or eliminated. As a result, it is possible to prevent rattling between the pipe connection portion 22 and the first fit-engagement portion 33. The spherical portion 22a of the pipe connection portion 22 abuts or comes close to the seating face 37 of the first fit-engagement portion 33. As a result, it is possible to prevent mutual rattling between the first fit-engagement portion 33 and the pipe connection portion 22. The gap means a part of a partially minimized gap between two members.

The divergent portion 12a of the tube 12 is fit-engaged with the large-diameter fit-engagement portion 41 of the cover body 31. A predetermined gap is formed between the large-diameter fit-engagement portion 41 and the divergent portion 12a. The divergent portion 12a can be fit-engaged with the large-diameter fit-engagement portion 41 so as to allow displacement. As a result, when the divergent portion 12a is fit-engaged with the large-diameter fit-engagement portion 41, it is possible to prevent interference between the divergent portion 12a and the large-diameter fit-engagement portion 41. Alternatively, after the divergent portion 12a is fit-engaged with the large-diameter fit-engagement portion 41, it is possible to prevent friction between the divergent portion 12a and the large-diameter fit-engagement portion 41. The gap between the large-diameter fit-engagement portion 41 and the divergent portion 12a may be set to be small. This helps to prevent mutual rattling between the large-diameter fit-engagement portion 41 and the divergent portion 12a.

The non-divergent portion 12b of the tube 12 is fit-engaged with the small-diameter fit-engagement portion 45 of the cover body 31. The non-divergent portion 12b can be fit-engaged with the small-diameter fit-engagement portion 45 while being in face-to-face contact therewith. As a result, the gap between the small-diameter fit-engagement portion 45 and the non-divergent portion 12b can be closed. Through the closing of the gap, the cover body 31 can support the non-divergent portion 12b.

The narrowing portion 46 of the small-diameter fit-engagement portion 45 is fit-engaged with the outer peripheral surface of the non-divergent portion 12b of the tube 12 (more specifically, the non-divergent portion 12b of the outer tube member 14) with a predetermined fastening margin by utilizing the elastic deformation of the outer tube member 14. This enables the cover body 31 to firmly support the non-divergent portion 12b. The second rib 57 of the cover body 31 is fit-engaged with the inner side of the corner made by the pipe connection portion 22 and the tube connection portion 23 (more specifically, the distal end portion 13a of the inner tube member 13) of the connector body 21. As a result, it is possible to prevent mutual rattling between the connector body 21 and the cover body 31.

Next, the lid 60 is attached to the cover member 31. That is, as shown in FIG. 18, the engagement claw 63a of the lid 60 is inserted into the first engagement hole 39 of the cover body 31 from the groove portion 31a. The lower end of the lid 60 is pressed towards the cover body 31. The engagement claw 63a is engaged with the first engagement hole 39. As a result, the upper end portion of the lid 60 is prevented from being detached from the cover body 31. At the same time, the first positioning recess 61 of the lid 60 is engaged with the first positioning protrusion 38 of the cover body 31. As a result, the lid 60 can be set in position with respect to the cover body 31. That is, upward movement of the lid 60 with respect to the cover body 31 is prevented, and movement in the right-left direction of the upper end of the lid 60 is prevented. At the same time, the positioning strength of the lid 60 with respect to the cover body 31 with respect to the right-left direction is enhanced.

As shown in FIG. 16, the two second engagement members 64 of the lid 60 are fit-engaged with the outer surfaces of the left wall 47 and the right wall 48 of the small-diameter fit-engagement portion 45 of the cover body 31. At this time, the engagement claws 64a are guided by the guide slopes 53 of the left wall 47 and the right wall 48, and the two second engagement members 64 are elastically deformed away from each other (See the chain double-dashed lines 64 in FIG. 16). After this, the engagement claws 64a reach the second engagement holes 51, and the second engagement members 64 are elastically restored, with the engagement claws 64a being engaged with the second engagement holes 51 (See FIG. 16). As a result, the lower end of the lid 60 is prevented from being detached from the cover body 31. At the same time, the second positioning recesses 62 of the lid 60 are engaged with the second positioning protrusions 50 of the cover body 31 (See FIG. 12). This enables the lid 60 to be set in position with respect to the cover body 31. That is, it is possible to prevent downward movement of the lid 60 with respect to the cover body 31, and movement in the right-left direction of the lower end of the lid 60.

The two second engagement members 64 are inclined so that the distance between the distal ends of the two second engagement members 64 may be a little smaller than the distance between the outer surfaces of the left wall 47 and of the right wall 48 in the free state of the second engagement members 64 (See FIGS. 14 and 15). As a result, when the engagement claws 64a are engaged with the second engagement holes 51, the second engagement members 64 can securely be in close contact with both outer surfaces of the left wall 47 and of the right wall 48.

The fit-engagement surface 65a of the lid 60 is fit-engaged with the outer peripheral surface of the non-divergent portion 12b of the tube 12 (more specifically, the non-divergent portion 12b of the outer tube member 14) (See FIG. 15). Thus, the lower end open between the non-divergent portion 12b of the tube 12 and the lid 60 can be closed. The fit-engagement surface 65a of the closing member 65 can become in face-to-face contact with the non-divergent portion 12b of the tube 12.

The third ribs 66 of the lid 60 are fit-engaged between the left wall 42 and the right wall 43 of the cover body 31. At this time, the third ribs 66 slide while guided by the guide slopes 66a with respect to the left wall 42 and the right wall 43. The left wall 42 and the right wall 43 are elastically deformed, and the distance between the left wall 42 and the right wall 43 is enlarged (See FIG. 17). Thus, it is possible to prevent mutual rattling between the cover body 31 and the lid 60 by utilizing the elasticity of the cover body 31. The two walls 42 and 43 of the large-diameter fit-engagement portion 41, and the third ribs 66 constitute a first rattling prevention means.

The stepped portions 67 of the lid 60 abut the front end of the left wall 42 and of the right wall 43 of the cover body 31 (See FIG. 17). The central portion in the vertical direction (See the chain double-dashed line 60a in FIG. 13) of the lid 60 (more specifically, the cover plate 60a) is deflected forwards. As a result, the engagement claw 63a of the first engagement member 63 is biased so as to abut the front edge of the first engagement hole 39 of the first engagement means. Further, the engagement claws 64a of the second engagement members 64 are biased so as to abut the front edge of the second engagement holes 51 of the second engagement means. Thus, it is possible to prevent mutual rattling between the cover body 31 and the lid 60. That is, it is possible to prevent rattling in the engagement of the first engagement means (the first engagement hole 39 and the first engagement member 63), and rattling in the engagement of the second engagement means (the second engagement holes 51 and the second engagement members 64). The two walls 42 and 43 of the large-diameter fit-engagement portion 41 and the third ribs 66 having the stepped portions 67 constitute a second rattling prevention means.

The connector cover 30 is attached to the connector body 21 of the connector 20 to which the tube 12 is connected as described above (See FIG. 1). After this, the pipe 10 is inserted into the pipe connection portion 22 of the connector body 21. After this, the retainer 26 is moved from the front position (the temporary fastening position) to the rear position (the locked position). As a result, the pipe 10 is prevented from detachment from the connector body 21.

The connector cover 30 is attached to the connector 20. In this state, the gap between the pipe connection portion 22 of the connector body 21 and the cover plate 60a of the lid 60 and/or the gap between the divergent portion 12a of the tube 12 and the cover plate 60a of the lid 60 is reduced or eliminated. The length in the front-rear direction of the third ribs 66 is set such that the third ribs 66 (See FIG. 12) abut the divergent portion 12a of the tube 12. This makes it possible to prevent mutual rattling between the tube 12 and the lid 60. The protrusion amount in the front-rear direction of fourth ribs 68 of the lid 60 (See FIG. 12) is set such that the fourth ribs 68 abut the pipe connection portion 22 of the connector body 21. This makes it possible to prevent mutual rattling between the connector body 21 and the lid 60.

The connector cover 30 (See FIG. 1) can protect the connector body 21 from external shock. In particular, the connector cover 30 can effectively protect the pipe connection portion 22, to which the pipe 10 is connected, and the connection portion of the tube connection portion 23, to which the tube 12 is connected, from external shock.

The cover body 31 of the connector cover 30 and the lid 60 are engaged with each other, with the connector body 21 being therebetween. As a result, the connector cover 30 covers the periphery of the connector body 21. The connector body 21 is provided with no attachment structure for attaching the connector cover 30 to the connector body 21. Thus, unlike the conventional example (See FIG. 19), the present embodiment allows formation of an attachment structure without a design change for the connector body 21. Further, the divergent portion 12a of the tube 12 is fit-engaged with the large-diameter fit-engagement portion 41 of the cover body 31. The non-divergent portion 12b of the tube 12 is fit-engaged with the small-diameter fit-engagement portion 45. As a result, the gap between the small-diameter fit-engagement portion 45 and the non-divergent portion 12b is decreased. This makes it possible to prevent intrusion of foreign matter into the connector cover 30 from the gap.

Further, the small-diameter fit-engagement portion 45 can be in face-to-face contact with and fit-engage with the non-divergent portion 12b of the tube 12. As a result, the gap between the small-diameter fit-engagement portion 45 and the non-divergent portion 12b of the tube 12 is closed. This makes it possible to prevent intrusion of foreign matter into the connector cover 30. The connector cover 30 is supported by the non-divergent portion 12b of the tube 12. This makes it possible to prevent mutual rattling between the tube 12 and the connector cover 30.

The cover body 31 and the lid 60 are asymmetrical with respect to the radial direction of the connector body 21. Thus, the cover body 31 and the lid 60 can be easily distinguished from each other. With regards to the arrangement of the connector mounted in a vehicle, there is a place easily subject to an external shock and a place not easily subject to an external shock, and it is possible to arrange the cover body 31 and the lid 60 in correspondence with those places. For example, it is possible to arrange the cover body 31 at the place easily subject to external shock, and to arrange the lid 60 at the place not easily subject to external shock.

The cover body 31 and the lid 60 are provided with a first rattling prevention means configured to prevent mutual rattling by utilizing the elasticity of the cover body 31. The first rattling prevention means has both walls 42 and 43 of the large diameter fit-engagement portion 41 of the cover body 31 and both third ribs 66 of the lid 60. Thus, by utilizing the elasticity of the cover body 31, it is possible to effectively prevent mutual rattling of the cover body 31 and the lid 60.

The cover body 31 and the lid 60 are provided with a second rattling prevention means configured to prevent mutual rattling by utilizing the elasticity of the lid 60 (more specifically, the cover plate 60a). The second rattling prevention means has walls 42 and 43 of the large-diameter fit-engagement portion 41 of the cover body 31 and third ribs 66 having the stepped portions 67 of the lid 60. Thus, by utilizing the elasticity of the cover plate 60a of the lid 60, it is possible to prevent mutual rattling of the cover body 31 and the lid 60. That is, it is possible to prevent rattling in the engagement of the first engagement means (the first engagement hole 39 and the first engagement member 63), and rattling in the engagement of the second engagement means (the second engagement holes 51 and the second engagement members 64). As a result, it is possible to prevent mutual rattling of the cover body 31 and the lid 60.

While the embodiments of invention have been described with reference to specific configurations, it will be apparent to those skilled in the art that many alternatives, modifications and variations may be made without departing from the scope of the present invention. Accordingly, embodiments of the present invention are intended to embrace all such alternatives, modifications and variations that may fall within the spirit and scope of the appended claims. For example, embodiments of the present invention should not be limited to the representative configurations, but may be modified, for example, as described below.

The connector 20 may be an elbow pipe as described above, or a connector having a connector body that is a straight-pipe in which the pipe connection portion 22 and the tube connection portion 23 are coaxially arranged. Alternatively, it may also be a connector disclosed in Japanese Laid-Open Patent Publication No. 2008-163976, Japanese Laid-Open Patent Publication No. 8-233181, etc.

The cover body 31 and the lid 60 constituting the two divisional bodies may be asymmetrical with respect to the radial direction of the connector body 21 as described above. Alternatively, the two divisional bodies may be symmetrical with respect to the radial direction of the connector body 21.

As described above, the small-diameter fit-engagement portion 45 of the cover body 31 may be in close contact with and fit-engaged with the non-divergent portion 12b of the tube 12. Alternatively, the small-diameter fit-engagement portion 45 may movably fit-engage with the non-divergent portion 12b of the tube 12.

The cover body 31 and the lid 60 may be separate members as described above, or may be connected with each other via an integral hinge.

1. A connector cover for covering a connector body having a pipe connection portion to which a pipe is connected and a tube connection portion to which a tube is connected, the connector cover comprising:
two divisional bodies formed through division in a radial direction of the connector body and configured to be capable of being engaged with each other,
wherein at least one of the divisional bodies comprises:
a large-diameter fit-engagement portion fit-engaged with a divergent portion of the tube connected to the tube connection portion, and
a small-diameter fit-engagement portion which is of a smaller opening diameter than that of the large-diameter fit-engagement portion and which is fit-engaged with a non-divergent portion of the tube adjacent to the large-diameter fit-engagement portion.

2. The connector cover of claim 1, wherein the divisional bodies are asymmetrical with respect to each other in the radial direction of the connector body.

3. The connector cover of claim 1, further comprising a rattling prevention means configured to prevent mutual rattling of the divisional bodies by utilizing elasticity of at least one of the divisional bodies.

4. The connector cover of claim 2, further comprising a rattling prevention means configured to prevent mutual rattling of the divisional bodies by utilizing elasticity of at least one of the divisional bodies.
